(19) United States
(12) Patent Application Publication
(10) Pub. No.: US 2026/0214090 A1
(43) Pub. Date: Jul. 23, 2026

(54) ORCHESTRATING AUTHENTICATION AND AUTHORIZATION OF USERS BETWEEN A CENTRALIZED CONTROLLER AND FEDERATED CONTROLLERS

(71) Applicant: Cisco Technology, Inc., San Jose, CA (US)

(72) Inventors: Vijay Sekhar Reddy, Foster City, CA (US); Ramesh Nethi, Bangalore (IN); Ankur Bhargava, Pleasanton, CA (US); Prashanth Patil, San Jose, CA (US)

(21) Appl. No.: 19/035,648

(22) Filed: Jan. 23, 2025

(51) Int. Cl. H04L 9/40

(52) U.S. Cl. CPC H04L 63/083

(57) ABSTRACT

Techniques for implementing centralized authentication and distributed authorization in a system for managing federated controllers. A centralized controller may be used to provide a unified interface for users to manage multiple federated controllers. After users request that the centralized controller unify the management of their network controllers, the federated controllers may perform techniques to register or enroll with the centralized controller. The centralized and federated controllers may establish trust such that the centralized controller may authenticate user identities on behalf of the federated controllers. The centralized controller may obtain access tokens indicating user identities from the federated controllers and may later send the access tokens to the federated controllers along with operation requests for authenticated users. The federated controllers use the access tokens and local access policies to authorize the users to determine if the users can perform operations or access resources.

### TECHNICAL FIELD

The present disclosure relates generally to techniques for a centralized authentication and distributed authorization system for managing federated controllers.

### BACKGROUND

Software-Defined Networking (SDN) controllers are centralized software platforms that manage and control network devices and resources in various network architectures and domains. SDN controllers serve as the “brain” of the network, abstracting the underlying hardware and providing a programmatic interface for configuring, managing, and optimizing network operations. This centralization simplifies network management, increases agility, and improves scalability. Due to the usefulness of SDN controllers, networking vendors have developed and offered various SDN controllers to help customers manage many different network domains (e.g., Security, SD-WAN, data center, enterprise, etc.). Utilizing many different SDN controllers can present various challenges, such as interoperability issues caused by different protocols, lack of unified visibility across the SDN controllers, policy coordination, and scalability coordination.

With SDN controllers exerting so much control over networks, authentication and authorization are critical aspects for managing access to these SDN controllers. Traditional authentication approaches often require users to maintain separate credentials for different SDN controllers and repeatedly authenticate when accessing various controllers. This can lead to poor user experiences, security vulnerabilities from password reuse, and administrative overhead in managing multiple identity stores. Single sign-on (SSO) technologies have emerged to address some of these challenges by allowing a user to authenticate once and gain access to multiple systems. However, implementing SSO across heterogeneous environments with different authentication mechanisms remains difficult. Additionally, authorization determining what specific actions and resources a user should be allowed to access-is often tightly coupled with authentication in many controllers. Thus, as networks become more distributed, there is a growing need for flexible authentication and authorization architectures that can span multiple domains while maintaining security and scalability.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a centralized controller enables centralized user authentication while allowing for distributed, federated controllers to perform distributed authorization.

FIGS. 2A and 2B collectively illustrate a sequence diagram of example communications for a centralized controller to enroll federated controllers in order to achieve centralized authentication and distributed authorization of users with the federated controllers.

FIG. 3A illustrates a system-architecture diagram of an environment in which a centralized controller authenticates a user, and sends operation requests to federated controllers along with access tokens for the authenticated user.

FIG. 3B illustrates a system-architecture diagram of an environment in which federated controllers perform localized authorization operations for a user, and either performs the requested operation of prevents the operations based on the authorization operation.

FIG. 4 illustrates a component diagram of an example centralized controller.

FIG. 5 illustrates a flow diagram of an example method for a centralized controller to facilitate centralized authentication and distributed authorization with federated controllers.

FIG. 6 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to a centralized controller that manages federated controllers to orchestrate authentication and authorization of users.

A first method described herein includes enrolling federated controllers with a centralized controller that provides a unified interface through which users interact with the federated controllers. Further, the first method includes exchanging communication credentials between the centralized controller and the federated controllers that enable bi-direction communication between the centralized controller and the federated controllers. The first method further includes receiving, at the centralized controller, an authentication request from a user enrolled with the centralized controller, and performing, by the centralized controller, an authentication process to authenticate an identity the user. The first method further includes receiving, at the centralized controller, an operation request to cause a first federated controller of the federated controllers to perform an operation, and based at least in part on authenticating the identity of the user, obtaining, by the centralized controller, an access token usable by the first federated controller to determine permissions of the user based on the identity of the user. The first method further includes sending, from the centralized controller, the access token and an indication of the operation requested to be performed to the first federated controller.

A second method described herein for a centralized controller that manages federated controllers to orchestrate authentication and authorization of users includes enrolling federated controllers with a centralized controller that provides a unified interface through which users interact with the federated controllers. The second method further includes receiving, at the centralized controller, an authentication request from a user enrolled with the centralized controller, and performing, by the centralized controller, an authentication process to authenticate an identity the user. The second method additionally includes receiving, at the centralized controller, an operation request to cause a first federated controller of the federated controllers to perform an operation, and identifying, by the centralized controller, an access token usable by the first federated controller to determine permissions of the user based on the identity of the user. Further, the second method includes sending, from the centralized controller, the access token and an indication of the operation requested to be performed to the first federated controller.

Additionally, the techniques of at least the first method and second method, and any other techniques described herein, may be performed by a system and/or device having non-transitory computer-readable media storing computer-executable instructions that, when executed by one or more processors, performs the method(s) described above.

### EXAMPLE EMBODIMENTS

This disclosure describes techniques for implementing centralized authentication and distributed authorization in a system for managing federated controllers. In some cases, a centralized controller may be used to provide a unified interface for users to interact with multiple federated controllers. After users request that the centralized controller unify the management of their disparate network controllers, the federated controllers may perform techniques to register or enroll with the centralized controller. The centralized and federated controllers may establish trust such that the centralized controller is able to authenticate the identity of users once on behalf of all the federated controllers. The centralized controller may obtain access tokens for the different user identities from the federated controllers and pass the access tokens for the authenticated identities to the federated controllers with which the authenticated users wish to interact. The individual federated controllers use the access tokens and local access policies to locally authorize the users to determine if the users can perform certain operations or access certain resources. Accordingly, the centralized controller implements centralized authentication while allowing for distributed authorization by the federated controllers.

Users that manage networks may utilize various types of network controllers to manage different networking domains, such as data center controllers, SD-Access controllers, SD Wide Area Network (SD-WAN) controllers, wireless and switching controllers, security controllers, and enterprise or branch network controllers. While it is advantageous to use specialized SDN controllers to manage these different network domains, traditional authentication approaches require users to maintain separate credentials for each SDN controller and repeatedly authenticate when accessing the various controllers. This can lead to poor user experiences, security vulnerabilities from password reuse, and administrative overhead in managing multiple identity stores. While SSO technologies have emerged to address some of these challenges by allowing a user to authenticate once and gain access to multiple systems, users generally have different scopes of authorization or permissions on each of the controllers. Accordingly, SSO technologies are unable to ensure that users are appropriately permitted or restricted from performing actions and access resources across the different SDN controllers.

According to the techniques described herein, users may access a portal, console, or other interface of the centralized controller to declare their desire to federate their controllers under the centralized controller. The federated controllers may host an agent that is capable of determining that the users declared this desire, such as through an advertisement from the centralized controller or through a trusted registration service (e.g., cloud-based registration service). In some examples, the trusted registration service is used to orchestrate communications between the centralized controller and the federated controllers. The federated controllers reach out to the registration service to discover information about the centralized controller, and obtain registration tokens from the registration service. The registration service may determine that the federated controllers are authentic controllers utilized by the user, and provide the registration tokens to the federated controllers. Similarly, the centralized controller may communicate with the registration service to obtain token validation details that are usable to validate the registration tokens provided to the federated controllers.

The federated controllers may then present their registration tokens to the centralized controller to authenticate themselves as being deemed trustworthy by the registration service. The centralized controller utilizes the token validation details to validate the registration tokens and enroll the federated controllers. After enrollment, the centralized and federated controllers may exchange credentials for bi-directional communication, such as Open Authentication (OAuth) credentials and Application Programming Information (API) details (e.g., discovery API), JSON Web Token (JWT) and Transport Layer Security (TLS) Certificates, centralized controller endpoints, notifications, etc. Further, the each of the federated controllers may provide respective access tokens that indicate identities for the users that are registered with the federated controllers. The centralized controller may then store or cache the access tokens for all of the federated controllers.

After enrollment and registration of the federated controllers by the centralized controller, users may begin interfacing with all of the federated controllers via a single, unified interface provided by the centralized controller. The user may initially perform authentication with the centralized controller using any type of authentication mechanism (e.g., password-based authentication, multi-factor authentication (MFA), Biometric Authentication, Token-based Authentication, Certificate-based Authentication, Challenge-Response Authentication, Behavioral Authentication, etc.). The centralized controller is then able to determine the identity of the user, and determine which access tokens belong to that user for each of the federated controllers. In some instances, each network controller may be associated with its own separate access token. In other examples, the federated controllers may include replicas or fleets of controllers of the same type that shared access tokens. The centralized controller may store mappings between user identities, access tokens, and federated controllers.

Because the federated controllers and centralized controller were able to register and prove trustworthiness to each other through the registration service (and/or directly with each other in embodiments where a registration service is not utilized), the federated controllers may trust that the centralized controller accurately and securely authenticated the users and determined their identities. In this way, the centralized controller may perform a single authentication process to determine the identity of the user rather than the user having to authenticate with each federated controller directly. Further, the centralized controller may enforce a more stringent authentication process than the federated controllers and improve security, such as enforcing an MFA authentication process rather than a simple username and password authentication used by a federated controller.

The users may begin using the unified interface provided by the centralized controller to request operations be performed on one or more of the federated controllers (e.g., cause network operations to be performed, request that data be pulled from the federated controllers, etc.). In some instances, the users may request that the same or similar operations be performed by a group or all of their federated controllers contemporaneously. For instance, a user may request, via the unified interface, that the federated controllers each provide data indicating the number of security events logged in their respective domains over the previous week. As another example, the user may request that all federated controllers with a particular configuration have an update or patch applied for that configuration.

Once users are authenticated, the centralized controller may generally behave as a communication proxy, such as an API proxy, and proxy communications and data between the users and federated controllers. The centralized controller may store, such as in a database or library, indications of the APIs used to communicate with the different federated controllers. Based on the operation request submitted by the users, the centralized controller may select the appropriate APIs to use when communicating the operation requests to the appropriate federated controllers. In addition to selecting the appropriate APIs, the centralized controller may select the appropriate access tokens for each federated controller that is usable by the respective federated controllers to determine a local identity of the user and perform authorization process(es) for the user based on their identity (e.g., use access policies to determine authorizations or permissions). The centralized controller may populate the appropriate APIs with the operation request information from the user and send the API calls along with the access tokens to the federated controllers.

Upon receiving the operation requests in the API and the access tokens, the federated controllers may initially perform authorization processes to determine permissions of the user(s) that are requesting the operations be performed. For example, the federated controllers may each use the respective access tokens to locally determine the identity of the users. Using the identity of the users and access policies defined for the federated policies, the federated controllers may determine local, federated controller-specific permissions for the users. The federated controllers may determine whether the users are permitted or restricted from causing performance of the requested operations (e.g., accessing resources, causing network operations to be performed, modifying configurations, pulling data, etc.).

In examples where users are permitted to perform requested operations, the federated controllers may perform the operations requested by the users. The federated controllers may further provide results of the operations and/or the requested data back to the centralized controller to be viewed by the users via the unified interface. In other examples, the users may not be permitted to perform the requested operations, and the federated controllers may refrain from performing the requested operations. The federated controllers may further provide an indication that the requested operation was not performed, and potentially a reason as to why the requested operation was not performed.

By performing authorization locally on the federated controllers, it should be noted that some federated controllers may allow a particular user to perform a requested operation, but other federated controllers may disallow the same user from performing the same operation. In this way, the federated controllers are able to maintain control over local authorization of users, but users still gain the benefit of a centralized authentication process.

The techniques described herein improve the functioning of distributed systems across different domains that require authentication and authorization of users. Rather than having users authenticate with each individual federated controller (or other system or device), the techniques described herein allow for a centralized controller to authenticate users on behalf of the distributed or federated controllers. This may provide additional benefits, such as only having to update the authentication processes on the centralized controller, rather than each federated controller, when new authentication technology emerges or when federated controllers are unable to implement certain authentication technologies (e.g., MFA). In this way, the centralized controller performing authentication increases the security on behalf of the federated controllers by strengthening authentication. However, the techniques described herein also allow for federated controllers to maintain their control over authorization of users, thereby allowing more granular control as to what users are able to perform what operations across networks and domains.

The techniques described herein may enable efficient management across network domains and federated controllers 112 by combining centralized authentication with distributed authorization. Users may interact with multiple network domains through a unified interface, while the centralized controller respects the individual authorization requirements of each federated controller. This approach may provide a balance between unified control and individual domain autonomy, allowing for flexible and secure network management across diverse network architectures.

In some cases, the system may support cross-launch functionality between controllers, enabling operations that span multiple federated controllers. The centralized controller may orchestrate these operations, facilitating seamless interactions across different network domains while maintaining proper authentication and authorization. The integration of these components and functionalities may offer several benefits in managing federated controllers. These benefits may include simplified user management, improved visibility across different network domains, enhanced security through distributed authorization, and streamlined network operations. By providing a unified management framework with distributed control, the system may help organizations efficiently manage and secure complex network environments.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

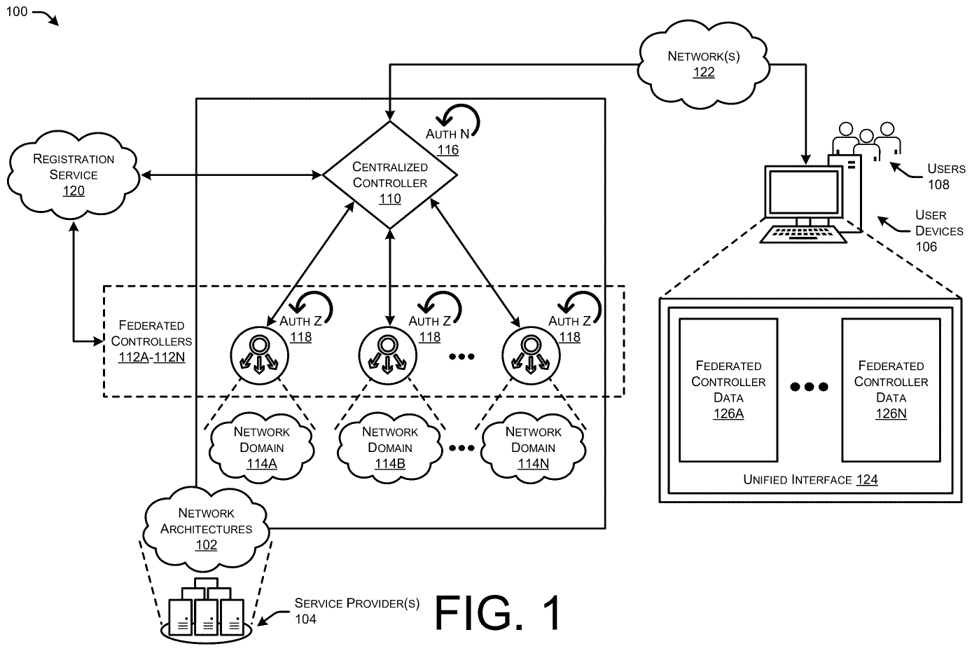

FIG. 1 illustrates a system-architecture diagram of an environment 100 in which a centralized controller enables centralized user authentication while allowing for distributed, federated controllers to perform distributed authorization.

The environment 100 may include one or more network architecture(s) that are managed or provided by one or more service providers 104 that provide networks and/or network services to users 108 via their user devices 106. The network architecture 102 may include a centralized controller 110 that communicates with and manages federated controllers 112A-112N. Generally, the centralized controller 110 is a centralized software platform that serves as a proxy and management platform through which users 108 can interact with their federated controllers 112 through a programmatic interface. The federated controllers 112 may each comprise any type of network controller, such as data center controllers, SDA controllers, SD-WAN controllers, wireless and switching controllers, security controllers, and enterprise or branch network controllers. the federated controllers 112 may each manage or control one or more respective network domains 114A-114N (where “N” is any integer greater than one as described herein). The network domains 114A-114N may similarly be any type of network domain, or network-related domain, that may be managed by controllers, such as data centers, SDA networks, SD-WAN networks, wireless and switching networks, security domains, and enterprise or branch networks.

The users 108 may register for and use the federated controllers 112 to manage their different network domains 114. According to the techniques described herein, the users 108 may access a portal, console, or other unified interface 124 of the centralized controller 110 to declare their desire to federate their controllers 112 under the centralized controller 110. The federated controllers 112 may host an agent that is capable of determining that the users 108 declared this desire, such as through an advertisement from the centralized controller 110 or through a registration service 120 that is trusted by all the controllers (e.g., cloud-based registration service). In some examples, the registration service 120 is used to orchestrate communications between the centralized controller 110 and the federated controllers 112. The federated controllers 112 reach out to the registration service 120 to discover information about the centralized controller 110, and obtain registration tokens from the registration service 120. The registration service 120 may determine that the federated controllers 112 are authentic controllers utilized by the user 108, and provide the registration tokens to the federated controllers 112. Similarly, the centralized controller 110 may communicate with the registration service 120 to obtain token validation details that are usable to validate the registration tokens provided to the federated controllers 112.

In some instances, the registration service 120 may be a cloud-based entity to facilitate secure communication and trust establishment between the centralized controller 110 and the federated network controllers 112. In some cases, the centralized controller 110 may advertise information to the cloud entity, including its public certificate and IP address. This information may be used to establish the centralized controller's 110 identity and enable secure communication channels. Federated controllers 112 may receive public information, certificate information, and signing details from the cloud entity. This information may allow the federated controllers 112 to verify the identity of the centralized controller 110 and establish secure connections. By obtaining this information from a trusted cloud entity (e.g., registration service 120), the techniques describe herein may reduce the risk of unauthorized access or impersonation attempts.

The centralized controller 110 and federated network controllers 112 may use a customized authentication mechanism similar to OAuth (or actually OAuth) for establishing initial trust. This mechanism may involve a series of token exchanges and validations, allowing the components to verify each other's identities and establish secure communication channels. The customized approach may be tailored to the specific needs of the network management system, providing enhanced security and flexibility.

For instance, the federated controllers 112 may then present their registration tokens to the centralized controller 110 to authenticate themselves as being deemed trustworthy by the registration service 120. The centralized controller 110 utilizes the token validation details to validate the registration tokens and enroll the federated controllers 112. After enrollment, the centralized controller 110 and federated controllers 112 may exchange credentials for bi-directional communication, such as OAuth credentials and API details (e.g., discovery API), JWT and TLS Certificates, centralized controller 110 endpoints, notifications, etc. Further, the each of the federated controllers 112 may provide respective access tokens that indicate identities for the users 108 that are registered with the federated controllers 112. The centralized controller 110 may then store or cache the access tokens for all of the federated controllers 112.

Once trust is established, the centralized controller 110 may handle user authentication, while the federated controllers 112 maintain control over authorization processes. This approach may allow for a streamlined user experience, with a single point of authentication, while preserving the ability of individual network domains 114 to enforce their specific access policies and security rules.

After enrollment and registration of the federated controllers 112 by the centralized controller 110, users may begin interfacing with all of the federated controllers 112 via a single, unified interface 124 (or “dashboard”, “console”, etc.) provided by the centralized controller 110. The user 108 may initially perform authentication 116 with the centralized controller 110 using any type of authentication mechanism (e.g., password-based authentication, MFA, Biometric Authentication, Token-based Authentication, Certificate-based Authentication, Challenge-Response Authentication, Behavioral Authentication, etc.). The centralized controller 110 is then able to determine the identity of the user 108, and determine which access tokens belong to that user 108 for each of the federated controllers 112. In some instances, each network controller may be associated with its own separate access token. In other examples, the federated controllers 112 may include replicas or fleets of controllers of the same type that shared access tokens. The centralized controller 110 may store mappings between user identities, access tokens, and federated controllers 112.

Because the federated controllers 112 and centralized controller 110 were able to register and prove trustworthiness to each other through the registration service (and/or directly with each other in embodiments where a registration service is not utilized), the federated controllers 112 may trust that the centralized controller 110 accurately and securely authenticated the users 108 and determined their identities. In this way, the centralized controller 110 may perform a single authentication 116 process to determine the identity of the user 108 rather than the user 108 having to authenticate with each federated controller 112 directly. Further, the centralized controller 110 may enforce a more stringent authentication process than the federated controllers 112 and improve security, such as enforcing an MFA authentication process rather than a simple username and password authentication used by a federated controller 112.

The users 108 may begin using the unified interface provided by the centralized controller 110 to request operations be performed on one or more of the federated controllers 112 (e.g., cause network operations to be performed, request that data be pulled from the federated controllers 112, etc.). In some instances, the users 108 may request that the same or similar operations be performed by a group or all of their federated controllers 112 contemporaneously. For instance, a user 108 may request, via the unified interface, that the federated controllers 112 each provide data indicating the number of security events logged in their respective domains over the previous week. As another example, the user 108 may request that all federated controllers 112 with a particular configuration have an update or patch applied for that configuration.

Once users 108 are authenticated, the centralized controller 110 may generally behave as a communication proxy, such as an API proxy, and proxy communications and data between the users and federated controllers 112. The centralized controller 110 may store, such as in a database or library, indications of the APIs used to communicate with the different federated controllers 112. Based on the operation request submitted by the users 108, the centralized controller 110 may select the appropriate APIs to use when communicating the operation requests to the appropriate federated controllers 112. In addition to selecting the appropriate APIs, the centralized controller 110 may select the appropriate access tokens for each federated controller 112 that is usable by the respective federated controllers 112 to determine a local identity of the user 108 and perform authorization 118 process(es) for the user 108 based on their identity (e.g., use access policies to determine authorizations or permissions). The centralized controller 110 may populate the appropriate APIs with the operation request information from the user and send the API calls along with the access tokens to the federated controllers 112.

Upon receiving the operation requests in the API and the access tokens, the federated controllers 112 may initially perform authorization 118 processes to determine permissions of the user(s) 108 that are requesting the operations be performed. For example, the federated controllers 112 may each use the respective access tokens to locally determine the identity of the users 108. Using the identity of the users 108 and access policies defined for the federated policies, the federated controllers 112 may determine local, federated controller-specific permissions for the users 108. The federated controllers 112 may determine whether the users are permitted or restricted from causing performance of the requested operations (e.g., accessing resources, causing network operations to be performed, modifying configurations, pulling data, etc.).

In examples where users 108 are permitted to perform requested operations, the federated controllers 112 may perform the operations requested by the users 108. The federated controllers 112 may further provide results of the operations and/or the requested data back to the centralized controller 110 to be viewed by the users 108 via the unified interface 124, such as the federated controller data 126A-126N that is received from one or more of the federated controllers 112A-112N. In other examples, the users 108 may not be permitted to perform the requested operations, and the federated controllers 112 may refrain from performing the requested operations. The federated controllers 112 may further provide an indication that the requested operation was not performed, and potentially a reason as to why the requested operation was not performed, which may be presented in the federated controller data 126A-126N in the unified interface 124.

By performing authorization 118 locally on the federated controllers 112, it should be noted that some federated controllers 112 may allow a particular user 108 to perform a requested operation, but other federated controllers 112 may disallow the same user 108 from performing the same operation. In this way, the federated controllers 112 are able to maintain control over local authorization 118 of users 108, but users still gain the benefit of a centralized authentication 116 process.

In some examples, the network architecture(s) 102 may include devices housed or located in one or more data centers or other physical locations. The network architecture 102 may include one or more networks implemented by any viable communication technology, such as wired and/or wireless modalities and/or technologies. The network architecture 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network architecture 102 may include devices, virtual resources, or other nodes that relay packets from one network segment to another by nodes in the computer network. The network architecture 102 may include multiple devices that utilize the network layer (and/or session layer, transport layer, etc.) in the OSI model for packet forwarding, and/or other layers. The network architecture 102 may include various hardware devices, such as routers, switches, gateways, smart NICs, NICs, ASICs, FPGAs, servers, and/or any other type of device. Further, the network architecture 102 may include virtual resources, such as VMs, containers, and/or other virtual resources.

The one or more data centers may be physical facilities or buildings located across geographic areas that designated to store networked devices that are part of the network architecture 102. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth).

The user devices 106 may establish communication connections over one or more networks 122 to communicate with devices in the network architecture 102, such as a centralized controller 110 of the network architecture 102. The network(s) 122 may include any viable communication technology, such as wired and/or wireless modalities and/or technologies. Networks 122 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The user devices 106 may communicate using any type of protocol over the network 122, such as the transmission control protocol/Internet protocol (TCP/IP) that is used to govern connects to and over the Internet.

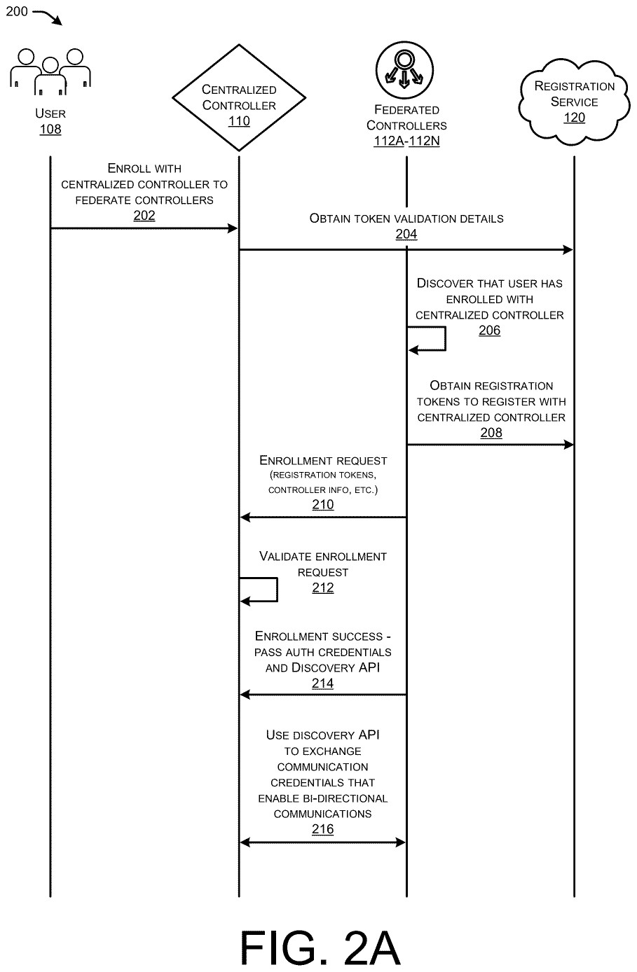

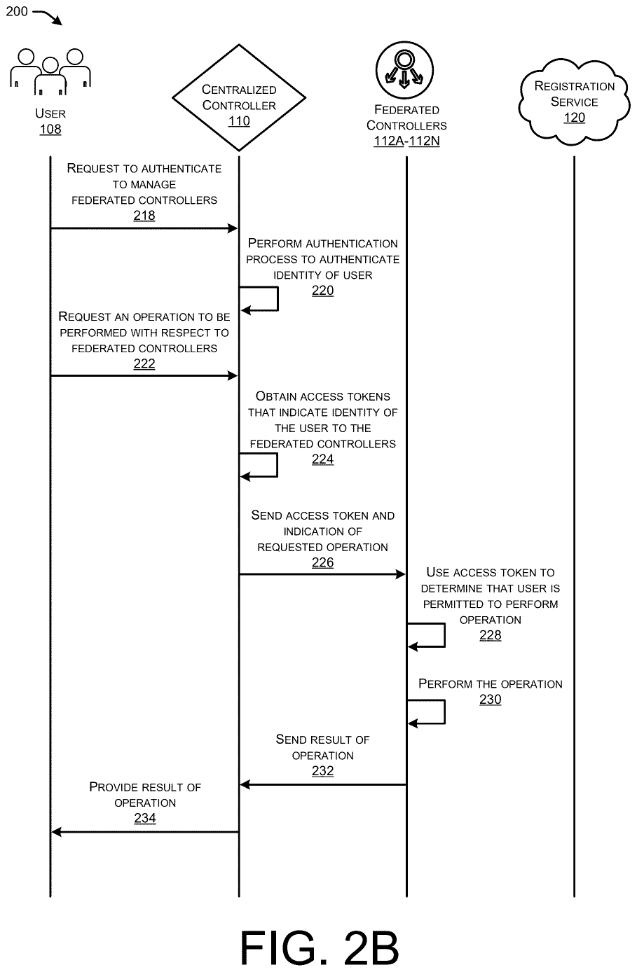

FIGS. 2A and 2B collectively illustrate a sequence diagram 200 of example communications for a centralized controller 110 to enroll federated controllers 112 in order to achieve centralized authentication and distributed authorization of users 108 with the federated controllers 112.

At 202, a user 108 may enroll with the centralized controller 110 to federate their network controllers under the centralized controller 110. The users 108 may register for and use the federated controllers 112 to manage their different network domains 114. According to the techniques described herein, the users 108 may access a portal, console, or other interface of the centralized controller 110 to declare their desire to federate their controllers 112 under the centralized controller 110.

At 204, the centralized controller 110 may obtain token validation details from the registration service 120. For instance, the centralized controller 110 may communicate with the registration service 120 to obtain token validation details that are usable to validate the registration tokens provided to the federated controllers 112.

At 206, the federated controllers 112 may discover that the user 108 has enrolled with the centralized controller 110. For instance, the federated controllers 112 may host an agent that is capable of determining that the users 108 declared this desire, such as through an advertisement from the centralized controller 110 or through a registration service 120 that is trusted by all the controllers (e.g., cloud-based registration service).

At 208, the federated controllers 112 may obtain registration tokens from the registration service 120 to register with the centralized controller 110. In some examples, the registration service 120 is used to orchestrate communications between the centralized controller 110 and the federated controllers 112. The federated controllers 112 reach out to the registration service 120 to discover information about the centralized controller 110, and obtain registration tokens from the registration service 120. The registration service 120 may determine that the federated controllers 112 are authentic controllers utilized by the user 108, and provide the registration tokens to the federated controllers 112.

At 210, the federated controllers 112 may send an enrollment request to the centralized controller 110 where the enrollment request includes the registration tokens, information about each federated controller 112, and potentially other information. Thus, the federated controllers 112 may present their registration tokens to the centralized controller 110 to authenticate themselves as being deemed trustworthy by the registration service 120.

At 212, the centralized controller 110 utilizes the token validation details to validate the registration tokens and enroll the federated controllers 112.

At 214 and 216, and after enrollment, the centralized controller 110 and federated controllers 112 may exchange credentials for bi-directional communication, such as OAuth credentials and API details (e.g., discovery API), JWT and TLS Certificates, centralized controller 110 endpoints, notifications, etc. Further, the each of the federated controllers 112 may provide respective access tokens that indicate identities for the users 108 that are registered with the federated controllers 112. The centralized controller 110 may then store or cache the access tokens for all of the federated controllers 112.

At 218, the user 108 may request to authenticate with the centralized controller 110 to manage their federated controllers 112. That is, after enrollment and registration of the federated controllers 112 by the centralized controller 110, users 108 may begin interfacing with all of the federated controllers 112 via a single, unified interface 124 (or “dashboard”, “console”, etc.) provided by the centralized controller 110. The user 108 may initially perform authentication with the centralized controller 110 using any type of authentication mechanism (e.g., password-based authentication, MFA, Biometric Authentication, Token-based Authentication, Certificate-based Authentication, Challenge-Response Authentication, Behavioral Authentication, etc.).

At 220, the centralized controller 110 may perform an authentication process to authenticate and determine the identity of the user 108, and determine which access tokens belong to that user 108 for each of the federated controllers 112.

At 222, the user 108 may request that an operation be performed with respect to their federated controllers 112. For instance, the users may begin using the unified interface 124 provided by the centralized controller 110 to request operations be performed on one or more of the federated controllers 112 (e.g., cause network operations to be performed, request that data be pulled from the federated controllers 112, etc.). In some instances, the users may request that the same or similar operations be performed by a group or all of their federated controllers 112 contemporaneously. For instance, a user may request, via the unified interface, that the federated controllers 112 each provide data indicating the number of security events logged in their respective domains over the previous week. As another example, the user may request that all federated controllers 112 with a particular configuration have an update or patch applied for that configuration.

At 224, the centralized controller 224 may obtain access tokens that indicate an identity of the user 108 to the federated controllers 112. In some instances, each federated controller 112 may be associated with its own separate access token. In other examples, the federated controllers 112 may include replicas or fleets of controllers of the same type that shared access tokens. The centralized controller 110 may store mappings between user identities, access tokens, and federated controllers 112.

In some examples, the centralized controller 224 may send for an access token after authentication. In various examples, the centralized controller 224 may previously obtain the access tokens and store them or cache them locally until needed. Further examples include the centralized controller 224 generating the access tokens after a user has authenticated.

At 226, the centralized controller 110 may send an access token and indication of a requested operation to the federated controllers 112. Based on the operation request submitted by the users 108, the centralized controller 110 may select the appropriate APIs to use when communicating the operation requests to the appropriate federated controllers 112. In addition to selecting the appropriate APIs, the centralized controller 110 may select the appropriate access tokens for each federated controller 112 that is usable by the respective federated controllers 112 to determine a local identity of the user 108 and perform authorization process(es) for the user based on their identity (e.g., use access policies to determine authorizations or permissions). The centralized controller 110 may populate the appropriate APIs with the operation request information from the user and send the API calls along with the access tokens to the federated controllers 112. While API calls are described as being used herein, any other communication mechanism may be used as well.

At 228, the federated controllers 112 may use the access token to determine that the user 108 is permitted to perform the operations. Upon receiving the operation requests in the API and the access tokens, the federated controllers 112 may initially perform authorization processes to determine permissions of the user(s) that are requesting the operations be performed. For example, the federated controllers 112 may each use the respective access tokens to locally determine the identity of the users 108. Using the identity of the users 108 and access policies defined for the federated policies, the federated controllers 112 may determine local, federated controller-specific permissions for the users 108. The federated controllers 112 may determine whether the users 108 are permitted or restricted from causing performance of the requested operations (e.g., accessing resources, causing network operations to be performed, modifying configurations, pulling data, etc.).

At 230, the federated controllers 230 may perform the operations in examples where users are permitted to perform requested operations. At 232, the federated controllers 112 may further provide results of the operations and/or the requested data back to the centralized controller 110 to be viewed by the users via the unified interface at 234.

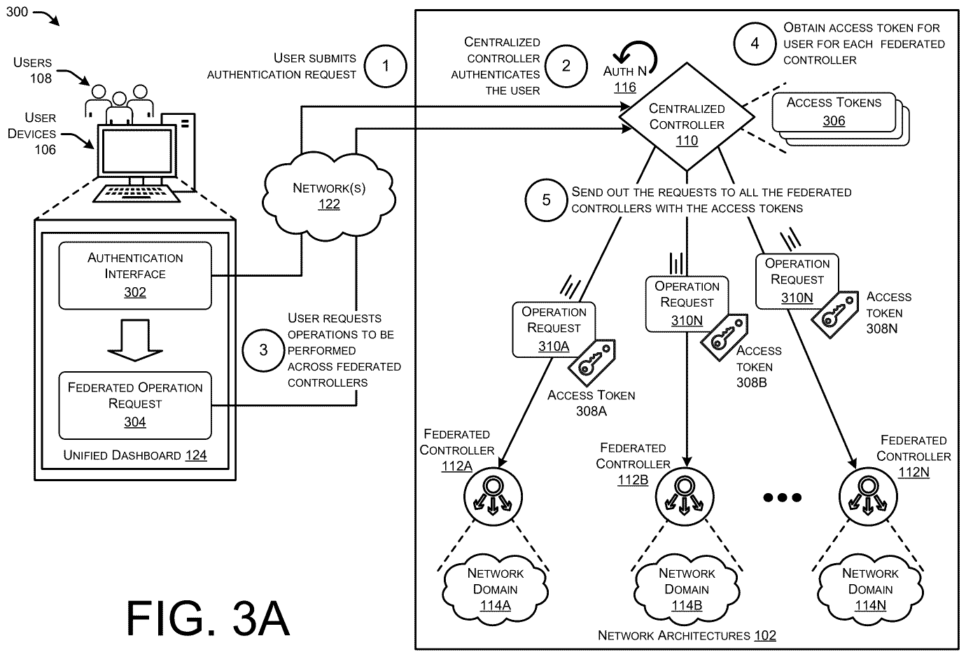

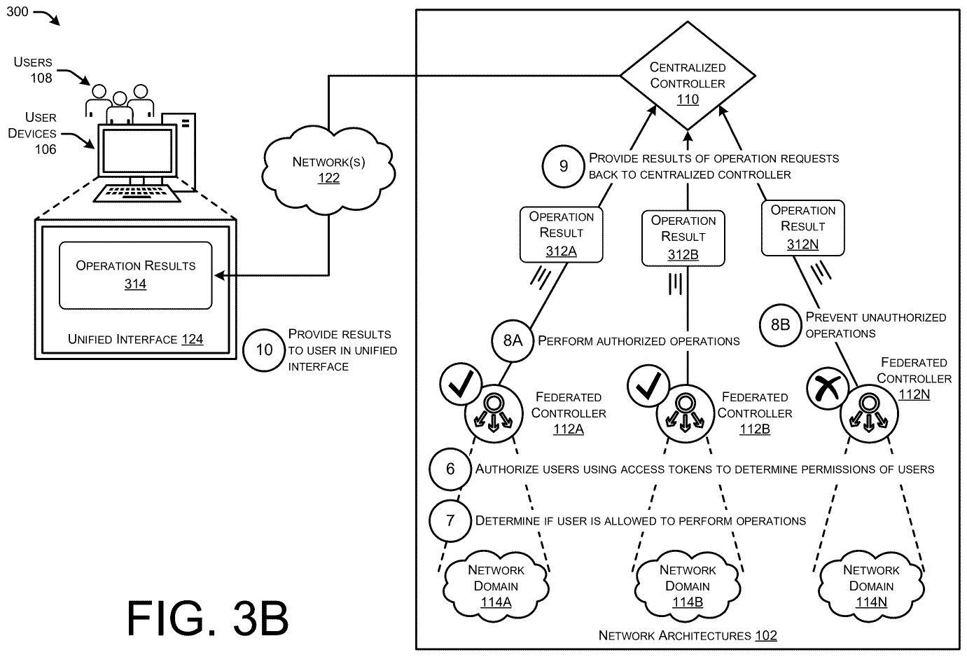

FIG. 3A illustrates a system-architecture diagram of an environment 300 in which a centralized controller 110 authenticates a user 108, and sends operation requests to federated controllers 112 along with access tokens for the authenticated user.

At “1,” a user 108 submits an authentication request via an authentication interface 302 presented via the unified interface 124. The authentication request may comprise any type of authentication mechanism or process. At “2,” the centralized controller 110 may authenticate the user 108 using one or more authentication 116 processes or mechanisms.

At “3,” the user 108 may then submit a federated operation request 304 via the unified interface 124. The centralized controller 110 may then, at “4” obtain access tokens 306 for the user 108 for each federated controller 112. At “5,” the centralized controller 110 may send out the operation requests 310 along with the access tokens 308 to all the federated controllers 112.

FIG. 3B illustrates a system-architecture diagram of an environment in which federated controllers perform localized authorization operations for a user, and either performs the requested operation of prevents the operations based on the authorization operation.

In FIG. 3B, and at “6,” the federated controllers 112 may authorize the users 108 using the access tokens 308 to determine the permissions of the users 108. At “7,” the federated controller 112 may determine if the user 108 is allowed to perform the requested operations. At “8A,” federated controller 112A and federated controller 112B may perform the operations for the user 108 based on determining that the user 108 is authorized to perform the operations. At “8B,” however, the federated controller 112N may prevent the operation from being performed based at least in part on the user 108 not being authorized to cause performance of the operation.

At “9,” the federated controllers 112 may provide operation results 312 of the operation requests 310 to the centralized controller 110. At “10,” the centralized controller 110 may provide the operation results 314 to the user 108 to view via the unified interface 124.

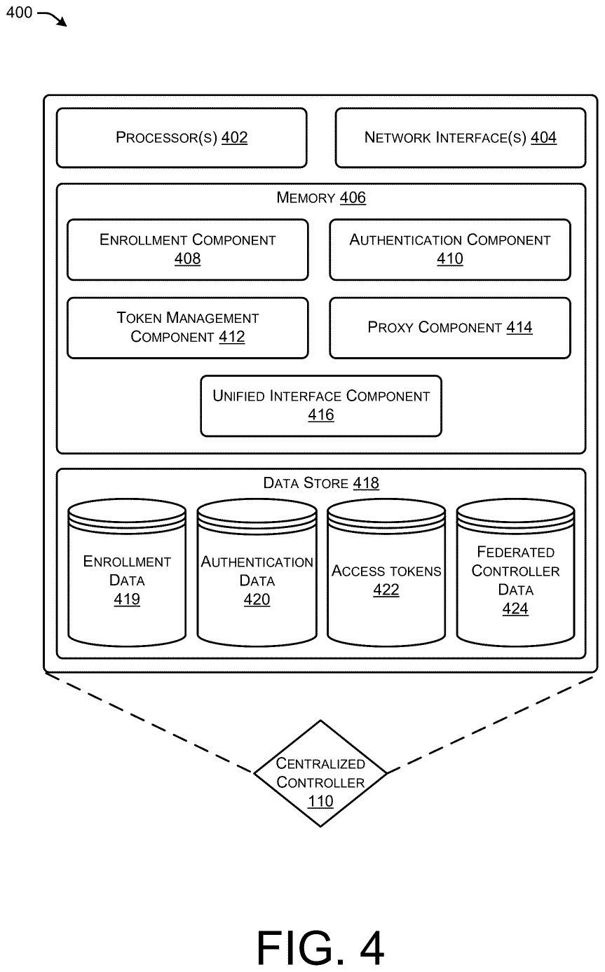

FIG. 4 illustrates a component diagram 400 of an example centralized controller 110. As illustrated, the centralized controller 110 may include one or more hardware processors 402 (processors), one or more devices, configured to execute one or more stored instructions. The processor(s) 402 may comprise one or more cores. Further, the centralized controller 110 may include one or more network interfaces 404 configured to provide communications between the centralized controller 110 and other devices, such as the federated controller 112, user devices 106, and/or other systems or devices in the network architecture 102 and/or remote from the network architecture 102. The network interfaces 404 may include devices configured to couple to personal area networks (PANs), wired and wireless local area networks (LANs), wired and wireless wide area networks (WANs), and so forth. For example, the network interfaces 404 may include devices compatible with Ethernet, Wi-Fi, and so forth.

The centralized controller 110 may also include memory 406, such as computer-readable media, that stores various executable components (e.g., software-based components, firmware-based components, etc.). The memory 406 may generally store components to implement functionality described herein. The memory 406 may store an operating system utilized to control the operation of components of the centralized controller 110. Further, the memory 406 may store a communication component that comprises software (e.g., any protocol stack) to enable the centralized controller 110to communicate with other devices using the network interface 404. Even further, the memory 406 may store one or more applications 216, which may generally comprise any type of software application to perform various functionalities.

The memory 406 may include several operational components: an enrollment component 408 for managing controller enrollment, an authentication component 410 for handling user authentication, a token management component 412 for managing access tokens, and a proxy component 414 for routing requests. A unified interface component 416 may provide an interface for presenting information to the user 108 via the unified interface 124.

The centralized controller 110 may include a data store 418 containing multiple data repositories. These repositories may include enrollment data 419 storing controller enrollment information, authentication data 420 containing user authentication details, access tokens 422 for storing token information, and federated controller data 424 maintaining information about connected federated controllers 112.

The components may work together to enable the centralized controller 110 to manage authentication and authorization across multiple federated controllers 112A-112N. The processor 402 may execute instructions from the components stored in the memory 406, while the network interface 404 may enable communication with external systems and controllers. The data store 418 may maintain the persistent data needed for system operation.

In some cases, the proxy component 414 may be responsible for proxying API requests from the unified interface 124 to any of the federated controllers 112A-112N. The proxy component 414 may insert access tokens required for the federated controllers 112A-112N. These access tokens may be obtained from the access tokens 422 stored in the data store. In some instances, the proxy component 414 may include trace headers and provide metrics for serviceability. These trace headers and metrics may allow for improved monitoring and troubleshooting of API requests across the network architectures 102.

The authentication component 410 may handle the authentication process 116 when a user 108 submits an authentication request through one of the user devices 106. The authentication component 410 may verify the user's credentials against the authentication data 420 stored in the data store.

The token management component 412 may be responsible for obtaining and managing access tokens 306 for each of the federated controllers 112A-112N. These access tokens 306 may be stored in the access tokens 422 data repository for quick retrieval during API requests.

The enrollment component 408 may manage the enrollment process for new federated controllers 112. The enrollment component 408 may communicate with the registration service 120 to obtain necessary credentials and store enrollment information in the enrollment data 419 repository.

The unified interface component 416 may provide the functionality for the unified interface 124, allowing users 108 to interact with all federated controllers 112A-112N through a single interface. The unified interface component 416 may work in conjunction with the proxy component 414 to route requests and aggregate responses from multiple federated controllers 112.

In some cases, the centralized controller 110 may use the components to manage complex operations across multiple network domains. For example, when a user 108 initiates a federated operation request 304, the unified interface component 416 may receive the request and pass it to the proxy component 414. The proxy component 414 may then determine which federated controllers 112A-112N are involved in the operation.

The token management component 412 may retrieve the appropriate access tokens 306 from the access tokens 422 repository. The proxy component 414 may then distribute the operation requests, such as the operation requests 310A-310N, to the respective federated controllers 112A-112N, including the necessary access tokens.

As the federated controllers 112A-112N process the requests and return results, such as the operation results 310, the proxy component 414 may aggregate these results. The unified interface component 416 may then present the combined results to the user 108 through the unified interface 124.

This architecture may allow the centralized controller 110 to provide a seamless management experience for users 108 while maintaining the distributed nature of authorization across the federated controllers 112A-112N. The unified controller 110 may enable efficient handling of authentication, token management, and request routing, supporting the overall functionality of the environment 100 for managing network architectures 102.

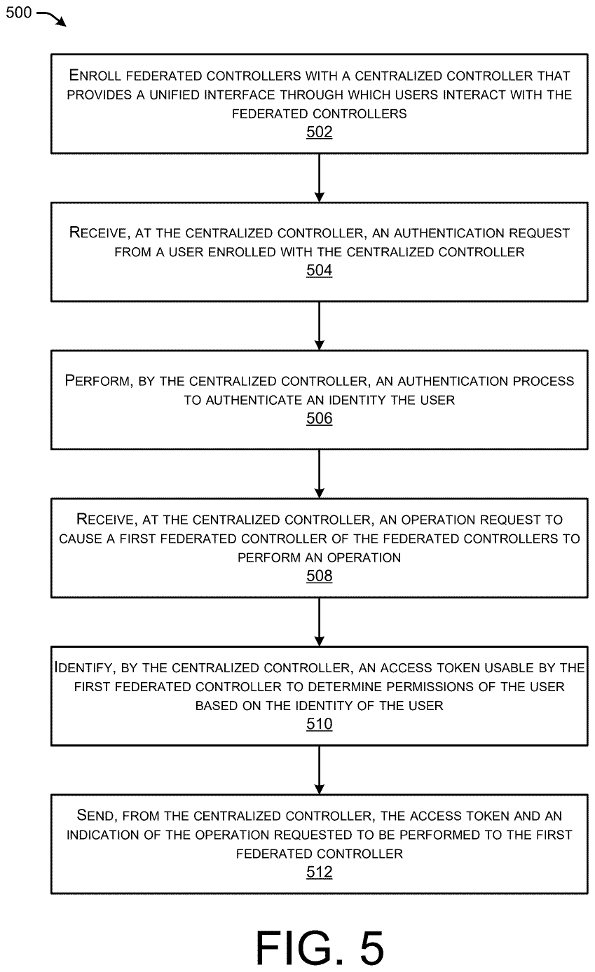

FIG. 5 illustrates a flow diagrams of example method 500 that illustrates aspects of the functions performed at least partly by the devices described in FIGS. 1-4, such as the centralized controller 110, user device 106, federated controller 112, and so forth. The logical operations described herein with respect to FIG. 5 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 5 illustrates a flow diagram of an example method for a centralized controller to facilitate centralized authentication and distributed authorization with federated controllers.

In some cases, the method 500 may begin at step 502 where federated controllers 112 are enrolled with a centralized controller 110 that provides a unified interface 124 through which users 108 interact with the federated controllers 112. This enrollment process may involve the registration service 120 facilitating secure communication between the centralized controller 110 and the federated controllers 112A-112N.

At 504, the centralized controller 110 may receive an authentication request from a user 108 enrolled with the centralized controller 110. This authentication request may be submitted through one of the user devices 106 connected to the networks 122.

At 506, the centralized controller 110 performs an authentication process to authenticate an identity of the user. The authentication component 410 of the centralized controller 110 may verify the user's credentials against the authentication data 420 stored in the data store.

At 508, the centralized controller 110 may receive an operation request to cause a first federated network controller of the federated controllers 112A-112N to perform an operation. This operation request may be submitted through the unified interface 124, which provides a centralized interface for interacting with multiple federated controllers.

At 510, the centralized controller 110 may identify an access token usable by the first federated network controller to determine permissions of the user based on the identity of the user. The token management component 412 may retrieve the appropriate access token from the access tokens 422 repository.

At 512, the centralized controller 110 may send the access token and an indication of the operation requested to be performed to the first federated network controller. The proxy component 414 may distribute the operation request, such as the first operation request 310A, to the respective federated controller, including the necessary access token.

In some cases, the method 500 may be repeated for multiple operation requests across different federated controllers. For example, the centralized controller 110 may simultaneously process requests for the first federated controller 112A and the federated controller 112N, following the same steps for each request. The method 500 may enable efficient management of authentication and authorization across the network architectures 102. By centralizing the authentication process and distributing the authorization to individual federated controllers 112, the method 500 may provide a balance between unified control and individual domain autonomy.

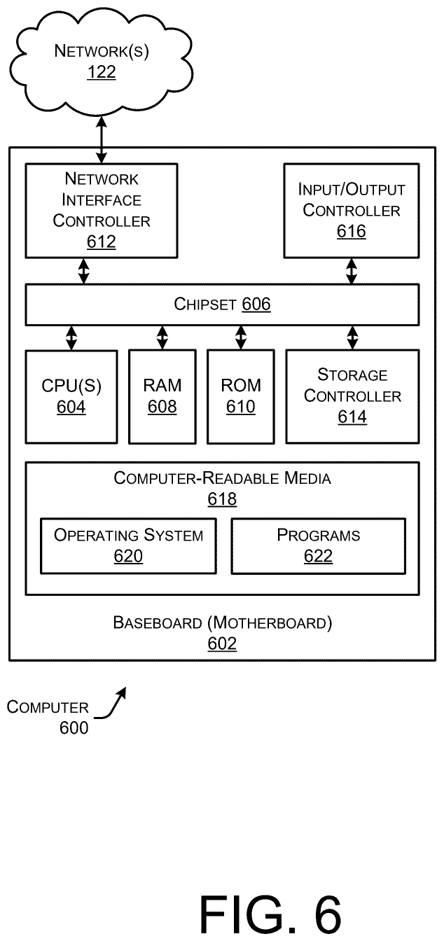

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer 600 may, in some examples, correspond to a centralized controller 110, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 122. The chipset 606 can include functionality for providing network connectivity through a NIC 612, such as a gigabit Ethernet adapter. The NIC 612 is capable of connecting the computer 600 to other computing devices over the network 122. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the user device 106, the centralized controller 110, and or any components included therein, may be supported by one or more devices similar to computer 600. Stated otherwise, some or all of the operations performed by user device 106 and/or centralized controller 110, and or any components included therein, may be performed by one or more of the computer 600 devices described herein.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIGS. 2 and/or 3, can include other components that are not explicitly shown in FIG. 6, or might utilize an architecture completely different than that shown in FIG. 6.

As described herein, the computer 600 may comprise one or more of a user device 106, a centralized controller 110, and/or any other device. The computer 600 may include one or more hardware processors (processors such as CPUs 604) configured to execute one or more stored instructions. The processor(s) (CPUs 604) may comprise one or more cores. Further, the computer 600 may include one or more network interfaces configured to provide communications between the computer 600 and other devices, such as the communications described herein as being performed by the user device 106 or centralized controller 110. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for a centralized controller that manages federated controllers to orchestrate authentication and authorization of users, the method comprising:
enrolling federated controllers with a centralized controller that provides a unified interface through which users interact with the federated controllers;
exchanging communication credentials between the centralized controller and the federated controllers that enable bi-direction communication between the centralized controller and the federated controllers;
receiving, at the centralized controller, an authentication request from a user enrolled with the centralized controller;
performing, by the centralized controller, an authentication process to authenticate an identity the user;
receiving, at the centralized controller, an operation request to cause a first federated controller of the federated controllers to perform an operation;
based at least in part on authenticating the identity of the user, obtaining, by the centralized controller, an access token usable by the first federated controller to determine permissions of the user based on the identity of the user; and
sending, from the centralized controller, the access token and an indication of the operation requested to be performed to the first federated controller.

2. The method of claim 1, further comprising:
receiving, at the first federated controller, the access token and the indication of the operation requested to be performed;
using the access token, determining the identity of the user associated with the operation request;
determining, at the first federated controller and using the identity of the user, that the user is permitted to perform the operation via the first federated controller;
performing the operation by the first federated controller; and
sending a result of the operation to the centralized controller.

3. The method of claim 1, further comprising:
receiving, at the first federated controller, the access token and the indication of the operation requested to be performed;
using the access token, determining the identity of the user associated with the operation request;
determining, at the first federated controller and using the identity of the user, that the user does not have permissions to perform the operation via the first federated controller; and
sending, to the centralized controller, an indication that the operation was not performed based at least in part on the user not having permissions to perform the operation.

4. The method of claim 1, further comprising:
receiving, at the centralized controller and from a remote registration service, token validation details usable to validate registration tokens;
receiving, at the centralized controller, registration tokens from the federated controllers; and
determining, using the token validation details, that the registration tokens were issued by the remote registration service,
wherein enrolling the federated controllers is performed based at least in part on determining that the registration tokens were issued by the remote registration service.

5. The method of claim 1, wherein:
the first federated controller is associated with managing a first networking domain from a group of networking domains; and
a second federated controller of the federated controllers is associated with a second networking domain from the group of networking domains that is different than the first networking domain.

6. The method of claim 5, wherein obtaining the access token usable by the first federated controller to determine permissions of the user based on the identity of the user comprises at least one of:
generating, at the centralized controller, the access token in response to successfully completing the authentication process; or
receiving, from the first federated controller, the access token for the user.

7. The method of claim 1, wherein:
receiving, at the centralized controller, a first result indicating that the operation was performed by the first federated controller based at least in part on the access token indicating to the first federated controller that the user is permitted to cause performance of the operation;
receiving, at the centralized controller, a second operation request to cause a second federated controller to perform a second operation;
sending, from the centralized controller, a second access token associated with the second federated controller and a second indication of the second operation; and
receiving, at the centralized controller, a second result indicating that the second operation was not performed by the second federated controller based at least in part on the second access token indicating to the second federated controller that the user is disallowed from causing performance of the second operation.

8. A system that supports a centralized controller that manages federated controllers to orchestrate authentication and authorization of users, the system comprising:
one or more processors; and
one or more non-transitory computer-readable media storing computer-executable instructions that, when executed by the one or more processors, cause the centralized controller to perform operations comprising:
enrolling federated controllers with a centralized controller that provides a unified interface through which users interact with the federated controllers;
exchanging communication credentials between the centralized controller and the federated controllers that enable bi-direction communication between the centralized controller and the federated controllers;
receiving, at the centralized controller, an authentication request from a user enrolled with the centralized controller;
performing, by the centralized controller, an authentication process to authenticate an identity the user;
receiving, at the centralized controller, an operation request to cause a first federated controller of the federated controllers to perform an operation;
based at least in part on authenticating the identity of the user, obtaining, by the centralized controller, an access token usable by the first federated controller to determine permissions of the user based on the identity of the user; and
sending, from the centralized controller, the access token and an indication of the operation requested to be performed to the first federated controller.

9. The system of claim 8, the operations further comprising:
receiving, at the first federated controller, the access token and the indication of the operation requested to be performed;
using the access token, determining the identity of the user associated with the operation request;
determining, at the first federated controller and using the identity of the user, that the user is permitted to perform the operation via the first federated controller;
performing the operation by the first federated controller; and
sending a result of the operation to the centralized controller.

10. The system of claim 8, the operations further comprising:
receiving, at the first federated controller, the access token and the indication of the operation requested to be performed;
using the access token, determining the identity of the user associated with the operation request;
determining, at the first federated controller and using the identity of the user, that the user does not have permissions to perform the operation via the first federated controller; and
sending, to the centralized controller, an indication that the operation was not performed based at least in part on the user not having permissions to perform the operation.

11. The system of claim 8, the operations further comprising:
receiving, at the centralized controller and from a remote registration service, token validation details usable to validate registration tokens;
receiving, at the centralized controller, registration tokens from the federated controllers; and
determining, using the token validation details, that the registration tokens were issued by the remote registration service,
wherein enrolling the federated controllers is performed based at least in part on determining that the registration tokens were issued by the remote registration service.

12. The system of claim 8, wherein:
the first federated controller is associated with managing a first networking domain from a group of networking domains; and
a second federated controller of the federated controllers is associated with a second networking domain from the group of networking domains that is different than the first networking domain.

13. The system of claim 12, wherein obtaining the access token usable by the first federated controller to determine permissions of the user based on the identity of the user comprises at least one of:
generating, at the centralized controller, the access token in response to successfully completing the authentication process; or
receiving, from the first federated controller, the access token for the user.

14. The system of claim 8, wherein:
receiving, at the centralized controller, a first result indicating that the operation was performed by the first federated controller based at least in part on the access token indicating to the first federated controller that the user is permitted to cause performance of the operation;
receiving, at the centralized controller, a second operation request to cause a second federated controller to perform a second operation;
sending, from the centralized controller, a second access token associated with the second federated controller and a second indication of the second operation; and
receiving, at the centralized controller, a second result indicating that the second operation was not performed by the second federated controller based at least in part on the second access token indicating to the second federated controller that the user is disallowed from causing performance of the second operation.

15. A method for a centralized controller that manages federated controllers to orchestrate authentication and authorization of users, the method comprising:
enrolling federated controllers with a centralized controller that provides a unified interface through which users interact with the federated controllers;
receiving, at the centralized controller, an authentication request from a user enrolled with the centralized controller;
performing, by the centralized controller, an authentication process to authenticate an identity the user;
receiving, at the centralized controller, an operation request to cause a first federated controller of the federated controllers to perform an operation;
identifying, by the centralized controller, an access token usable by the first federated controller to determine permissions of the user based on the identity of the user; and
sending, from the centralized controller, the access token and an indication of the operation requested to be performed to the first federated controller.

16. The method of claim 15, further comprising:
receiving, at the first federated controller, the access token and the indication of the operation requested to be performed;
using the access token, determining the identity of the user associated with the operation request;
determining, at the first federated controller and using the identity of the user, that the user is permitted to perform the operation via the first federated controller;
performing the operation by the first federated controller; and
sending a result of the operation to the centralized controller.

17. The method of claim 15, further comprising:
receiving, at the first federated controller, the access token and the indication of the operation requested to be performed;
using the access token, determining the identity of the user associated with the operation request;
determining, at the first federated controller and using the identity of the user, that the user does not have permissions to perform the operation via the first federated controller; and
sending, to the centralized controller, an indication that the operation was not performed based at least in part on the user not having permissions to perform the operation.

18. The method of claim 15, further comprising:
receiving, at the centralized controller and from a remote registration service, token validation details usable to validate registration tokens;
receiving, at the centralized controller, registration tokens from the federated controllers; and
determining, using the token validation details, that the registration tokens were issued by the remote registration service,
wherein enrolling the federated controllers is performed based at least in part on determining that the registration tokens were issued by the remote registration service.

19. The method of claim 15, wherein:
the first federated controller is associated with managing a first networking domain from a group of networking domains; and
a second federated controller of the federated controllers is associated with a second networking domain from the group of networking domains that is different than the first network domain.

20. The method of claim 15, wherein:
receiving, at the centralized controller, a first result indicating that the operation was performed by the first federated controller based at least in part on the access token indicating to the first federated controller that the user is permitted to cause performance of the operation;
receiving, at the centralized controller, a second operation request to cause a second federated controller to perform a second operation;
sending, from the centralized controller, a second access token associated with the second federated controller and a second indication of the second operation; and
receiving, at the centralized controller, a second result indicating that the second operation was not performed by the second federated controller based at least in part on the second access token indicating to the second federated controller that the user is disallowed from causing performance of the second operation.
